(19) United States
(12) Patent Application Publication
(10) Pub. No.: US 2024/0413567 A1
(43) Pub. Date: Dec. 12, 2024

(54) Touch Protection Sleeve for an HV Header

(71) Applicants: TE Connectivity India Private Limited, Bangalore (IN); TE Connectivity Czech s.r.o., Kurim (CZ)

(72) Inventors: Vignesh RAVICHANDIRAN, Bangalore (IN); Dharmendrajain Vedalaveni PARSWANATHAIAH, Bangalore (IN); Tomas SVATEK, Kurim (CZ); Miloslav HLAVINKA, Kurim (CZ)

(73) Assignees: TE Connectivity India Private Limited, Bangalore (IN); TE Connectivity Czech s.r.o., Kurim (CZ)

(21) Appl. No.: 18/735,245

(22) Filed: Jun. 6, 2024

(30) Foreign Application Priority Data
Jun. 9, 2023 (IN) 202341039570

(51) Int. Cl. H01R 13/516; H01R 13/648

(52) U.S. Cl. CPC H01R 13/516; H01R 13/648

(57) ABSTRACT

The invention relates to a touch protection sleeve for an HV header with at least one pin that protrudes along a plugging direction away from a base plate and has a touch protection cap at its distal end, wherein the touch protection sleeve is made from an injection moldable material and comprises at least one attachment section for attaching the touch protection sleeve to the header, wherein the touch protection sleeve forms a receptacle adapted to surround the pin in a spaced and HV touch protection manner.

This application claims priority to and the benefit of Indian patent application No. 202341039570 filed Jun. 9, 2023, which is hereby incorporated by reference in its entirety.

The invention relates to the field of high voltage (HV) connectors. In some applications, HV headers, i.e. connectors that are mounted to a fixed structure such as a housing or a board, are used. It is often necessary to ensure a safe operation by a human, for example to prevent contact to high voltage carrying parts during plugging and unplugging. However, such measures are usually expensive.

The object of the invention is to make the production of HV connectors, in particular HV headers, easier and more cost efficient, whilst keeping the operation safe.

According to the invention, this is achieved by a touch protection sleeve for an HV header with at least one pin that protrudes along a plugging direction away from a base plate and has a touch protection cap at its distal end, wherein the touch protection sleeve is made from an injection moldable material and comprises at least one attachment section for attaching the touch protection sleeve to the header, wherein the touch protection sleeve forms a receptacle adapted to surround the pin in a spaced and HV touch protection manner.

The fact that the touch protection sleeve is made from an injection moldable material makes the production easier and more cost efficient compared to previous solutions in which such a sleeve is made from a sheet metal by stamping and bending. The fact that the touch protection sleeve is a separate part allows using the previous full metal shield and the touch protection sleeve selectively in a modular manner depending on the needs of the specific application.

The solution according to the invention can further be improved by the following further developments and advantageous developments, which are independent of each other and can be combined arbitrarily, as desired.

The touch protection sleeve can, in particular, be used if no or little shielding effect is necessary at the pin. This can be the case if the line or cable associated with the pin is used for supplying power as a direct current (DC). A touch protection sleeve for such an application can be made from a low cost moldable material like simple plastic to keep the costs low. Shielding here refers to shielding against electric and/or magnetic fields from outside.

In other applications, a stronger shielding effect can be desired. In such a case, the material for the touch protection sleeve can for example be made from an injection moldable material that has shielding properties, for example by being electrically conductive. In one example, a plastic with a network of conductive material in it can be used to achieve a shielding effect while still being moldable.

Alternatively or in addition, a further, outer sleeve made from a metal can be attached to the touch protection sleeve to achieve a shielding, as will be explained in more detail later.

The attachment section can be configured for attaching the touch protection sleeve at the base plate. It can protrude from the rest of the touch protection sleeve in an axial direction of the pin and/or in the plugging direction.

In one embodiment, the touch protection sleeve may be configured such that the pin and the touch protection sleeve only have an indirect connection to each other. In particular, no direct connection or contact is then present. An intermediate part preferably made from an electrically insulating material can connect the two.

A touch protection effect can in particular be achieved when the pin and the touch protection sleeve are spaced at the distal end such that the contacting of a test finger with HV carrying parts is precluded. The size and shape of the test finger can be defined in norms or standards, for example national, international or company standards. Similarly, parameters of the pin, the header and the mating connector can be defined in such norms or standards.

In one embodiment, the touch protection sleeve can be adapted to be sealingly mounted to the base plate. With this measure, air and creep distances for the electric voltage at the pin can be extended, as no path exiting the touch protection sleeve at the base plate is possible.

According to one development, the touch protection sleeve may comprise two openings at two opposite ends, wherein one of the openings is adapted to be sealed by the base plate in the mounted state. In the mounted state, only one opening leading to the pin can then be present or open. This opening can be associated with the distal end and/or the touch protection cap of the pin. This can help to increase the creep and air distance for the pin.

In a particularly advantageous embodiment, the opening that is present in the mounted state is located entirely in a half space defined by a plane running perpendicular to an axial direction of the pin at a distance of at least 60% of the length of the pin away from the base plate. The creep and air paths can then be particularly long. Preferably, the distance is at least 70%, more preferably at least 80%, especially at least 90% of the length of the pin away from the base plate.

An opening should not be understood as a small gap between parts mounted to each other resulting from manufacturing or assembling tolerances, for example if below 1 mm, preferably below 0.1 mm. The decisive threshold value can depend on the fact whether current can flow through the gap, which in turn can depend on the maximum voltage for which the header is specified.

The attachment section can be located at the end where the opening sealed by the base plate is located to allow an easy mounting. This end can be named a proximal end and can be opposite the distal end or protruding end of the pin.

The attachment section can protrude from the receptacle along a plugging direction along which the header and the mating connector are plugged together. The plugging direction can also be the axial direction of the pin or be parallel thereto.

In a further embodiment, the attachment section can protrude from the rest of the touch protection sleeve along a radial direction of the pin, in particular outwardly. This can improve the stability of the connection as longer levers length then support the touch protection sleeve against tilting.

The attachment section can comprise two arms that are elastically deflectable in two opposing circumferential directions. This can facilitate the mounting.

To improve stability, the touch protection sleeve can comprise two or more attachment sections. Preferably, the attachment sections are distributed equally around an axis of the pin to improve the force distribution. They can be at equal angles from each other, for example at an angle of 360 degrees/n with n being the number of attachment sections.

In one embodiment, the touch protection sleeve can comprise at least one polarization feature allowing a mounting to the header at only a limited number of possible rotational positions, preferably only one rotational position. This can ensure a proper mounting of the touch protection sleeve to the header. The rotational position should be understood as a rotation around an axis of the pin.

In an advantageous embodiment, at least one attachment section acts as a polarization feature. The manufacturing of such a touch protection sleeve can be easier as only one feature has to be designed and produced.

According to one advantageous development, the touch protection sleeve may comprise at least one terminal lock assurance adapted to block a movement of a terminal lock in a mating connector out of a locking position.

The touch protection sleeve can comprise at least two terminal lock assurances each adapted to block a movement of a terminal lock, preferably the same terminal lock, in the mating connector out of a locking position. This can increase the safety.

In particular, the terminal lock assurances may be located at different depths along the plugging direction to increase the possible number of terminal lock assurances.

In addition or alternatively, the two terminal lock assurances are located at different rotational positions. This can help to further increase the number of terminal lock assurances.

In a development that is simple to manufacture, at least one terminal lock assurance may be formed as a thickened edge section. The edge can in particular be the edge or rim of one of the openings.

In particular, when there is insufficient or no shielding by the touch protection sleeve itself, the touch protection sleeve can be adapted for mounting at least one shield sleeve at an outside. For example, the outside of the touch protection sleeve can be at least in parts complementary to the inside of the shield sleeve. The shield sleeve can be made from metal or another conductive material. For such a shield sleeve that is used together with a touch protection sleeve, the material thickness can be thinner than a previous shield that is used without the touch protection sleeve. Further, the complexity can be lower. For example, certain elements that are present in the touch protection sleeve, such as an attachment section, do not have to be present on such a shield sleeve. The production of such a shield sleeve can thus be easier.

To limit the relative movement between the touch protection sleeve and the shield sleeve, the touch protection sleeve can comprise at least one shield engagement section adapted for engaging the shield sleeve. The shield engagement section can comprise at least one blocking face for blocking a movement of the shield sleeve relative to the touch protection sleeve. The movement can, in particular, be blocked or limited along and/or against the plugging direction, and/or in at least one circumferential direction that is perpendicular to the plugging direction.

The shield engagement section can comprise a protrusion protruding in a radial direction of the pin, or a recess in a radial direction. The shield sleeve can comprise corresponding counter elements that engage the protrusion or recess and form at least one counter blocking face.

The touch protection sleeve can comprise at least two shield engagement sections located at different depths and/or rotational positions. This can help to increase the number of locations where the two sleeves engage each other. The depth can be measured along the plugging direction and/or the axial direction of the pin.

In an embodiment that saves material, a wall section that forms at least one shield engagement section also forms a terminal lock assurance. The wall section can have at least the same thickness as the surrounding wall section to guarantee mechanical stability. Further, the wall section and the surrounding wall are preferably continuous (i.e. without holes or gaps through the wall) to preclude any unwanted current paths at this section.

According to one embodiment that saves space, at least one terminal lock assurance is located at the same depth and rotational position as a shield engagement section. However, the two can be located at different radii.

To further reduce the required space, the touch protection sleeve can comprise at least one wall section with an increased wall thickness, the wall section forming an outwardly protruding protrusion with a blocking face of a shield engagement section, wherein the wall section is a base section for at least one attachment section. As for some of the other developments, such a part then has a double function.

In an advantageous embodiment, the touch protection sleeve is a monolithic piece or, in other words, a single integral piece.

To facilitate the mounting, the touch protection sleeve has at least a two-fold rotational symmetry.

A base section of the touch protection sleeve can have a cylindrical shape, preferably a circular cylindrical shape, to achieve good mechanical stability.

The base section can form the receptacle for the pin. It can be tubular or have a shape similar to a channel that is open at two ends.

The invention also comprises a sleeve assembly comprising a touch protection sleeve, according to the invention, and an electrically conductive shield sleeve mounted around the touch protection sleeve.

The shield sleeve should be connected to a ground or earth potential when in use, in particular if it is made from a conductive material and part of a touch protection assembly. It is then not possible for a user to come into contact with high voltages.

Moreover, the invention also relates to an HV header with at least one pin protruding from a base plate, comprising at least one touch protection sleeve according to the invention mounted to the base plate.

Finally, in order to mount an element that suits a specific application, a set is provided that allows mounting either conventional shields or the touch protection sleeve according to the invention and thus comprises at least one touch protection sleeve according to the invention and at least one metallic shielding, wherein the touch protection sleeve and the metallic shielding can selectively and interchangeably be mounted around the same pin of a header and/or be plugged together with the same mating connector. The metallic shielding can in particular be a metallic shielding according to previous solutions.

The set can further comprise further parts of the header, for example the base plate, housing parts, and/or seals.

The invention will now be described in greater detail and in an exemplary manner using advantageous embodiments and with reference to the drawings. The described embodiments are only possible configurations in which the individual features as described above can be provided independently of one another or can be omitted.

### IN THE FIGURES

FIG. 1 shows a schematic, partially sectional perspective view of a header with two touch protection sleeves;

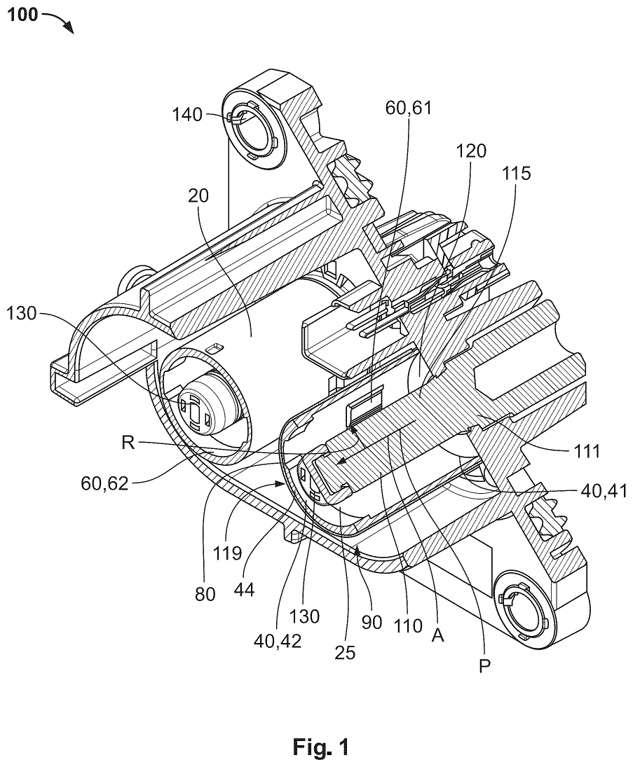

FIG. 2 shows a schematic perspective view of one of the touch protection sleeves of FIG. 1;

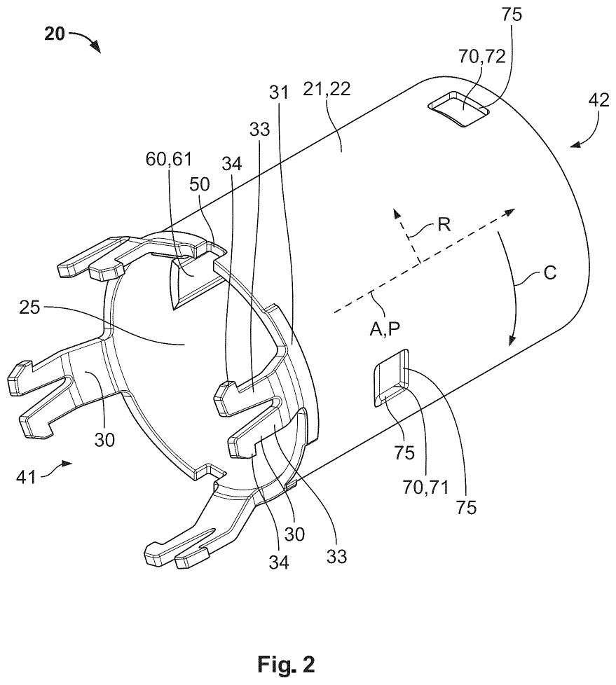

FIG. 3 shows a schematic sectional perspective view of one of the touch protection sleeves of FIG. 1 from a different viewpoint;

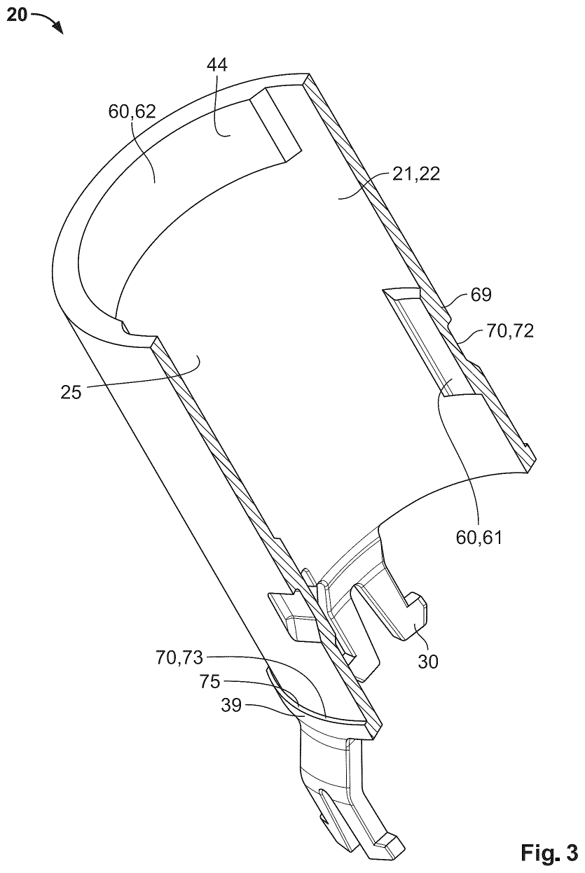

FIG. 4 shows a schematic perspective view of one of the touch protection sleeves of FIG. 1 together with a shield sleeve;

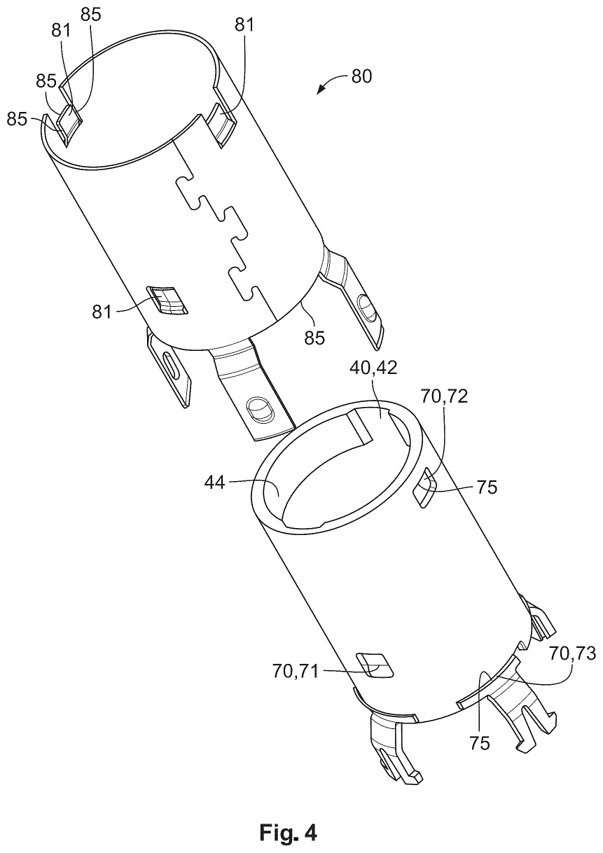

FIG. 5 shows a schematic perspective view of the header of FIG. 1 during the assembly;

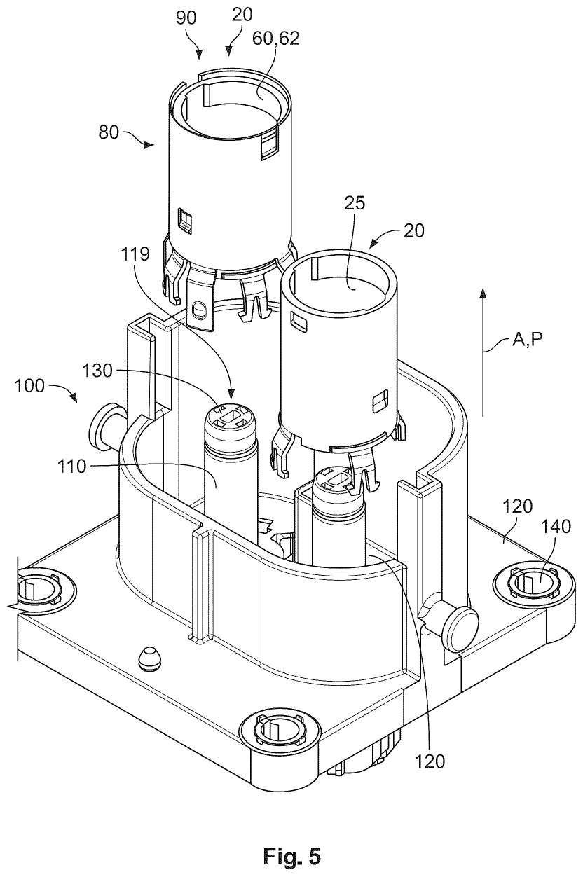

FIG. 6 shows a schematic sectional view of a header with two touch protection sleeves together with a mating connector;

FIG. 7 shows a detail of a further sectional view of the header of FIG. 6 taken in a plane 90° to the plane of FIG. 6.

The figures show an embodiment of a touch protection sleeve 20. In some figures, the touch protection sleeve is mounted to the rest of a header 100. Further, some figures show the touch protection sleeve 20 with a shield sleeve 80 mounted around it.

The touch protection sleeve 20 can be used to replace previous sleeves that are made entirely of metal, in particular in cases where no electromagnetic shielding or little shielding is required for the application. The touch protection sleeve 20 is usually made from a plastic material by injection molding, which is more cost-efficient than the production of a sleeve made entirely from metal.

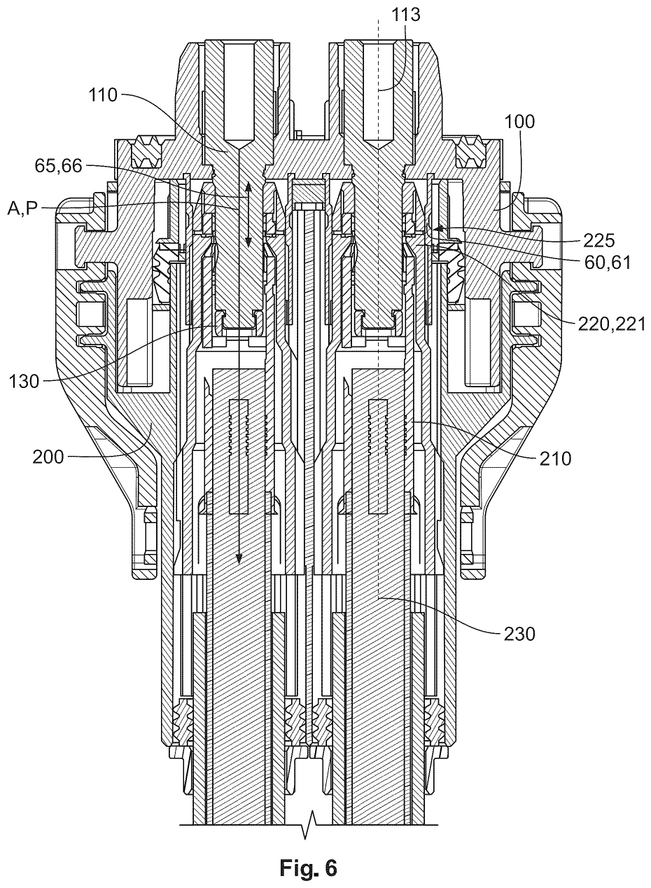

The header 100 comprises a base plate 120 that can for example be mounted and fixed to a housing of a device by inserting suitable fixing elements like screws into holes 140. At a front side, two pins 110 protrude along a plugging direction P away from the base plate 120. The plugging direction P is the direction along which the header 100 is plugged together with a mating connector 200 (see for example FIG. 6). The plugging direction P is in this example parallel to an axial direction A of the substantially cylindrical pin 110.

The pins 110 extend through the base plate 120 and protrude therefrom from a proximal end 111 up to a distal end 119, at which a touch protection cap 130 made from an insulating material is located. A pin body 115 of the pin 110 is made from a metallic material having good conducting properties, for example copper or aluminum.

The header 100, at which the touch protection sleeve 20 is mounted, is an example of an application. The touch protection sleeve 20 can also be used for other connectors having pins 110 protruding from a base plate 120.

Each touch protection sleeve 20 comprises a base section 21, which is in the depicted example configured as a substantially cylindrical base section 21, 22. The base section 21 forms a receptacle 25 for the pin 110 and the corresponding terminal 210 (or contact element) of the mating connector 200. When fully mounted, the pin 110 is surrounded by the terminal 210 of the mating connector 200, which is in turn surrounded by the base section 21. In an unmounted state or condition, the base section 21 surrounds the pin in a spaced and HV touch protection manner. The latter is, in particular, achieved by choosing the spacing between the pin 110 and the base section 21 such that a test finger cannot advance into the receptacle 25 far enough to be close or in touch with the potentially high voltage carrying pin body 115 of the pin 110.

From each base section 21 attachment sections 30 protrude against the plugging direction P and outwardly in radial directions R that are perpendicular to the axial direction A and the plugging direction P. The attachment sections 30 are distributed equally around circumferential direction C of the touch protection sleeve 20, namely at 90 degrees to each other for the case of four attachment sections 30.

Each attachment section 30 comprises two prongs or arms 33 that can be deflected elastically towards each other along the circumferential direction C. By pressing the two arms 33 towards each other, the width is decreased and the attachment section 30 can be inserted a corresponding hole in the base plate 120. The latching protrusions 34 located at the free ends of the arms 33 can engage with corresponding elements in the base plate when the attachment sections 30 are correctly inserted.

The attachment sections 30 are located at a first opening 40, 41 of the touch protection sleeve 20 that is associated with the proximal end 111 of the pin 110 and the base plate 120. Wall sections 39 at the opening 40, 41 have an increased wall thickness to increase stability and function as base sections 31 for the attachment sections 30.

When mounted, the first opening 40, 41 is covered by the base plate 120. To increase the air and creep distance, the first opening 40, 41 is configured to achieve a sealing contact with the corresponding sections on the base plate 120.

To facilitate the right orientation, each touch protection sleeve 20 has polarization features 50 that match corresponding features on the base plate 120 and allow the mounting of the touch protection sleeve 20 on the base plate 120 only in one or more allowed rotational positions about the axis 113 of the pin 110. In addition, the attachment sections 30 can also act as polarization features.

The pin 110 and the touch protection sleeve 20 are not connected directly but only via the intermediate base plate 120. This ensures that the two are electrically insulated from each other, for example if the touch protection sleeve 20 is made from a conductive material or if a shield sleeve 80 is attached.

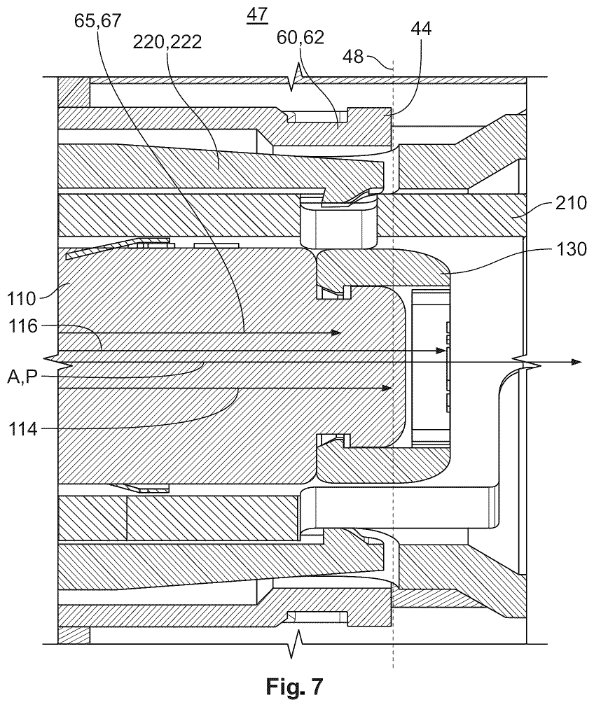

The touch protection sleeve 20, in particular the base section 21 and the receptacle 25 form a second opening 40, 42 located opposite the first opening 40, 41. The second opening 40, 42 is open when the touch protection sleeve is mounted and ensures that the terminal 210 of the mating connector 200 can access the conductive parts of the pin 110. In the mounted state, the second opening 40, 42 is the only opening that is open and provides access to the pin 110. This improves the high-voltage performance, as any air or creep path from one pin 110 to the other pin 110 has to go through the second opening 40, 42 and is thus longer than a direct connection, which is blocked by the wall of the base section 21. To maximize the length of the path, the second opening 40, 42 is located entirely in a half space 47 defined by a plane 48 running perpendicular to the axial direction A of the pin 110 at a distance 114 that is almost the length 116 of the pin 110, the distance 114 and the length 116 being measured from the point where the pin 110 exits the base plate 120 along the axial direction A including the touch protection cap 130 (see in particular FIG. 7).

Each touch protection sleeve 20 comprises several terminal lock assurances 60, 61, 62 adapted to block a movement of a terminal lock 220 in a mating connector 200 out of a locking position 225. Each terminal lock 220 is used to ensure that the terminal 210 is in the right position in the mating connector 200. The terminal lock 220 can only latch into a corresponding recess in the terminal 210 when the two are in the correct relative position to each other. Each of the terminal lock assurances 60, 61, 62 is automatically moved behind the corresponding terminal lock 220 when the header 100 and the mating connector 200 are plugged into each other. In this plugged state, the terminal lock assurances 60, 61, 62 form stops for the ends of the latching arms of the terminal locks 220.

The terminal lock assurances 60, 61, 62 can be grouped in first terminal lock assurances 60, 61 located at a first depth 66 measured along the plugging direction P, and second terminal lock assurances 60, 62, located at a second depth 67 different from the first depth 66.

Each group of terminal lock assurances 60, 61, 62 comprises two terminal lock assurances 60, 61, 62 that are located at different rotational positions about the axis of the pin 110, namely that opposite positions or in other words 180° relative to each other.

The second terminal lock assurances 60, 62 are formed as thickened edges 44 of the opening 42. This can make the production easy and improve the mechanical stability of the tubular or canal-like base section 21. Again, the group of the second terminal lock assurances 60, 62 comprises two terminal lock assurances 60, 62 that are arranged 180 degrees rotated to each other about the axis 113 of the pin 110. However, the second terminal lock assurances 60, 62 are offset 90° to the first terminal lock assurances 60, 61 to ensure a good force distribution around the circumference.

The terminals 210 of the mating connector 200 are connected to electrical lines or cables 230.

As mentioned before, the touch protection sleeve 20 can be used alone instead of a metallic shield, if no significant shielding effect is required for the application. The touch protection sleeve 20 is part of a modular system that however allows the addition of a shield sleeve 80. The touch protection sleeve 20 is adapted for mounting at least one shield sleeve 80 at an outside, for example by sliding the touch protection sleeve 20 into the shield sleeve 80 along the plugging direction P. To achieve a good fit, the outside of the touch protection sleeve 20 is substantially or in large parts complementary to the inside of the shield sleeve 80.

The shield sleeve 80 can be made from sheet metal by cutting and bending. In the mounted condition, the shield sleeve 80 is preferably connected to a ground or earth potential to avoid an electric shock of a user.

To improve the mechanical connection between the touch protection sleeve 20 and the shield sleeve 80 forming a sleeve assembly 90, the touch protection sleeve 20 comprises several shield engagement sections 70, 71, 72, 73 adapted for engaging the shield sleeve 80 and the shield sleeve 80 comprises corresponding engagement sections 81.

Each shield engagement section 70, 71, 72, 73 comprises at least one blocking face 35 for blocking a movement of the shield sleeve 80 relative to the touch protection sleeve 20. In the depicted examples, a rotation around two opposing rotational directions and a translational movement along and against the plugging direction are blocked.

On the touch protection sleeve 20, first and second shield engagement sections 70, 71, 72 are formed as substantially rectangular or box-shaped recesses that have three side walls that extend perpendicular to the outer face and function as blocking faces 75 and a fourth side wall that is slanted or ramp shaped.

Each of the shield engagement sections 70, 71, 72, 73 and the terminal lock assurances 60, 61, 62 is configured with a continuous wall section, i.e. there is no gap or hole in the wall of the touch protection sleeve 20.

The engagement sections 81 on the shield sleeve 80 are embodied as tabs or flaps that can be elastically deflected outwardly during the insertion of the touch protection sleeve 20 and that latch into the shield engagement sections 70, 71, 72 in the final position. A front face located at the free end of the tab and side faces act as the counter blocking face 85. An edge of an opening of the shield sleeve 80 acts as a further blocking face 85.

To simplify the design, wall section 69 of the touch protection sleeve 20 acts at the same time as a shield engagement section 70, 71 and a terminal lock assurance 60, 61. In other words, the terminal lock assurance 60, 61 is located at the same depth and rotational position as a shield engagement section 70, 71, but at a different radius.

Like the terminal lock assurances 60, 61, 62, the shield engagement sections 70, 71, 72, 73 are located at different depths and different rotational positions.

The wall sections 39 with an increased wall thickness form outwardly protruding protrusions with a blocking face 75 for the shield sleeve 80 and thus act as third shield engagement sections 70, 73.

The entire touch protection sleeve 20 is one single piece or a monolithic piece and is made from an injection moldable material.

The depicted embodiment of a touch protection sleeve 20 has a two-fold rotational symmetry to simplify mounting.

A set that allows mounting either conventional shields or the touch protection sleeve according to the invention comprises at least one touch protection sleeve 20 and at least one metallic shielding, wherein the touch protection sleeve 20 and the metallic shielding can selectively and interchangeably be mounted around the same pin 110 of a header 100. The metallic shielding can in particular be a metallic shielding according to previous solutions.

The set can further comprise further parts of the header 100, for example the base plate 110, housing parts, and/or seals.

### REFERENCE NUMERALS

20 touch protection sleeve
21 base section
22 cylindrical base section
25 receptacle
30 attachment section
31 base section
33 arm
34 latching protrusion
39 wall section
40 opening
41 first opening
42 second opening
44 thickened edge
47 half-space
48 plane
50 polarization feature
60 terminal lock assurance
61 first terminal lock assurance
62 second terminal lock assurance
65 depth
66 first depth
67 second depth
69 wall section
70 shield engagement section
71 first shield engagement section
72 second shield engagement section
73 third shield engagement section
75 blocking face
80 shield sleeve
81 engagement section
85 counter blocking face
90 sleeve assembly
100 header
110 pin
111 proximal end
113 axis
114 distance
115 pin body
116 length
119 distal end
120 base plate
130 touch protection cap
140 hole
200 mating connector
210 terminal
220 terminal lock
221 first terminal lock
222 second terminal lock
225 locking position
230 cable
A axial direction
C circumferential direction
P plugging direction
R radial direction

1. A touch protection sleeve for an HV header with at least one pin that protrudes along a plugging direction away from a base plate and has a touch protection cap at its distal end, wherein the touch protection sleeve is made from an injection moldable material and comprises at least one attachment section for attaching the touch protection sleeve to the header, wherein the touch protection sleeve forms a receptacle adapted to surround the pin in a spaced and HV touch protection manner.

2. The touch protection sleeve according to claim 1, wherein the touch protection sleeve is adapted to be sealingly mounted to the base plate.

3. The touch protection sleeve according to claim 1, wherein the touch protection sleeve comprises two openings at two opposite ends, wherein one of the openings is adapted to be sealed by the base plate in the mounted state.

4. The touch protection sleeve according to claim 3, wherein the opening associated with the distal end is located entirely in a half space defined by a plane running perpendicular to an axial direction of the pin at a distance of at least 60% of the length of the pin away from the base plate.

5. The touch protection sleeve according to claim 1, wherein the touch protection sleeve comprises at least one polarization feature allowing a mounting to the header at only a limited number of possible rotational positions, preferably only one rotational position.

6. The touch protection sleeve according to claim 1, wherein the touch protection sleeve comprises at least one terminal lock assurance adapted to block a movement of a terminal lock in a mating connector out of a locking position.

7. The touch protection sleeve according to claim 6, wherein the touch protection sleeve comprises at least two terminal lock assurances each adapted to block a movement of the terminal lock in the mating connector out of a locking position located at different depths along the plugging direction.

8. The touch protection sleeve according to claim 7, wherein two terminal lock assurances are located at different rotational positions.

9. The touch protection sleeve according to claim 6, wherein at least one terminal lock assurance is formed as a thickened edge section.

10. The touch protection sleeve according to claim 1, wherein the touch protection sleeve comprises at least one shield engagement section adapted for engaging a shield sleeve.

11. The touch protection sleeve according to claim 1, wherein a wall section that forms at least one shield engagement section also forms a terminal lock assurance.

12. The touch protection sleeve according to claim 1, wherein the touch protection sleeve comprises at least one wall section with an increased wall thickness, the wall section forming an outwardly protruding protrusion with a blocking face of a shield engagement section, wherein the wall section is a base section for at least one attachment section.

13. A sleeve assembly, comprising the touch protection sleeve according to claim 1 and an electrically conductive shield sleeve mounted around the touch protection sleeve.

14. An HV header with at least one pin protruding from a base plate, comprising at least one touch protection sleeve according to claim 1 mounted to the base plate.

15. A set comprising the touch protection sleeve according to claim 1 and a metallic shielding, wherein the touch protection sleeve and the metallic shielding can selectively and interchangeably be mounted around the same pin of a header.
